(19) United States
(12) Patent Application Publication
(10) Pub. No.: US 2004/0238713 A1
(43) Pub. Date: Dec. 2, 2004

(54) Mirror with slidable set

(76) Inventor: Lester L. Wegrzecki, Bloomfield Hills, MI (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/487,035

(22) PCT Filed: Jun. 11, 2003
(86) PCT No.: PCT/IB03/04406

(30) Foreign Application Priority Data
Jun. 12, 2002 (PL) W-113302

(51) Int. Cl. B60R 1/02; A47G 1/24

(52) U.S. Cl. 248/479

(57) ABSTRACT

A mirror with slidable set is disclosed having a primary mirror with a back surface and a slidable set integrated to the back surface. The slidable set includes at least one lever pair fixed with an articulated joint to the back surface of the primary mirror. An opposite end of the at least one lever pair is fixed with an articulated joint to at least one moveable element that is mounted slidably on at least one guide. The at least one guide is placed parallel to the back surface of the primary mirror and at a horizontal height generally the same as the horizontal height of the ends of the at least one lever pair. The moveable element is joined to a driving unit. The driving unit may comprise an electric motor with a switching on/off unit, a pneumatic actuator or a hydraulic actuator.

### CROSS-REFERENCE TO RELATED APPLICATIONS

This application claims priority to Polish patent application W-113302 filed on Jun. 12, 2002, and PCT/IB03/04406 filed on Jun. 11, 2003 and published on Jan. 8, 2004 having publication number WO 04/002282, the contents of which are incorporated herein in its entirety.

### FIELD OF THE INVENTION

The present invention relates generally to a mirror with slidable set, especially a bathroom mirror and more particularly to a mirror with slidable set having a primary mirror with integrated slidable set joined to a back surface.

### BACKGROUND OF THE INVENTION

Mirrors, commonly located in household bathrooms, are usually permanently fixed to a bathroom wall in vertical, adjacent or parallel position in relation to the wall, or at an angle in relation to the wall surface. These typical bathroom mirrors provide limited functionality for users. Often the mirror is placed behind a bathroom sink and the user would prefer the mirror positioned outwardly from the wall to permit closer examination.

For increasing functionality of the mirror, some mirrors have been designed to include side wings fixed with movable joints to vertical edges of a middle mirror. The side wings are often equipped with double-sided mirror surfaces that are adjustable away from the wall to accommodate a user's personal preference. Further, some bathrooms include supplemental mirrors that are equipped with a pullout folding arm fixed to the wall. However, the mirrors are typically small and the folding arms are often bulky. Overall, these units are of limited utility.

There is some inconvenience in each of the designs. By way of example, one particular inconvenience is that very close contact with the mirror surface is often difficult or impossible. Accordingly, there exists a need for a mirror that extends from the wall surface wherein the mechanism for moving the mirror is generally hidden when the mirror assembly is against the wall.

### BRIEF SUMMARY OF THE INVENTION

Accordingly, to overcome the inconveniences and deficiencies of mirrors in the prior art, the present invention discloses a mirror with slidable set that comprises a primary mirror having an integrated slidable set on a back surface. The slidable set further comprises an end of at least one lever pair fixed to the back surface of the primary mirror. An opposite end of the at least one lever pair is fixed to at least one moveable element that is slidably mounted to at least one guide. The at least one guide is placed parallel to the back surface of the primary mirror. The at least one moveable element is joined to a driving unit.

### BRIEF DESCRIPTION OF THE DRAWINGS

The features and inventive aspects of the present invention will become more apparent upon reading the following detailed description, claims, and drawings. The following is a brief description of the figures illustrating the present invention.

FIG. 1 is a front view of an embodiment of a mirror with slidable set of the present invention.

FIG. 2 is a cross-sectional side view of the mirror with slidable set of the present invention placed between two walls in a framework structure.

FIG. 3 is a front view of the mirror with slidable set of the present invention having a primary mirror moved away from a wall.

FIG. 4 is a cross-section view of the mirror with slidable set of the present invention having the primary mirror moved away from the wall.

FIG. 5 is a front view of a second embodiment of a mirror with slidable set of the present invention.

FIG. 6 is a cross-sectional side view of the second embodiment of the mirror with slidable set of the present invention placed between two walls in a framework structure.

### DETAILED DESCRIPTION OF THE INVENTION

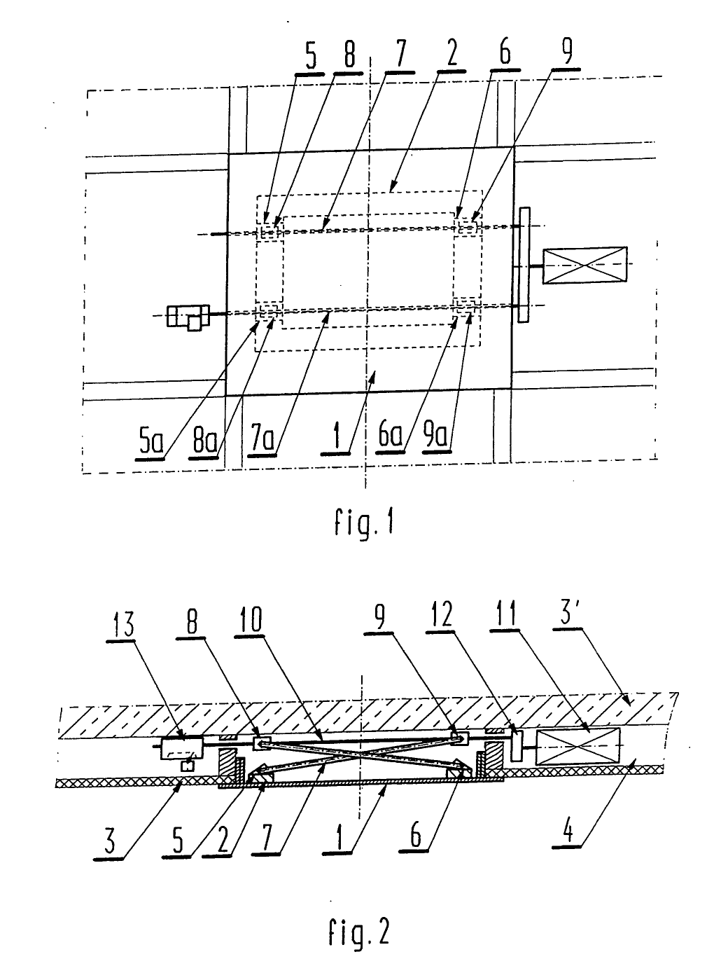

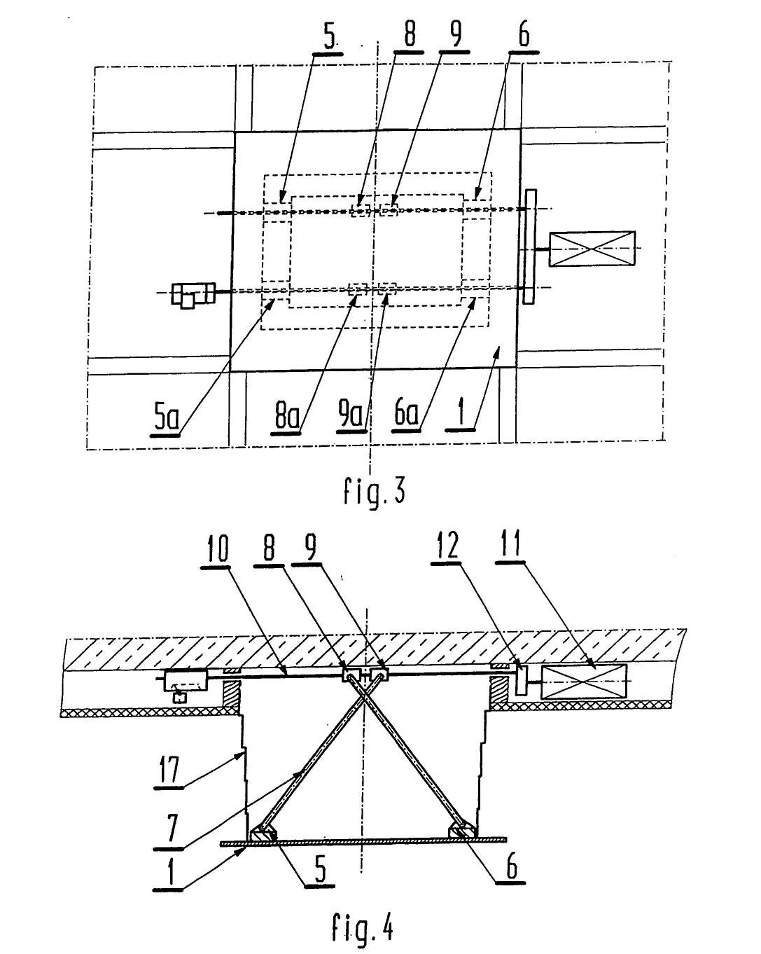

Referring to FIGS. 1-6, a mirror with slideable set comprises a primary mirror having a back surface 1 mounted on a frame 2 and permanently placed on a surface of or in direct proximity to a wall 3. On the back surface of the mirror 1 is a slidable set. The slidable set is placed in the frame 2 within a space 4 between a front wall 3 and a back wall 3′. The slidable set is integrated with the frame 2.

The slidable set includes a first lever pair 7 and a second lever pair 7a. Each lever pair 7, 7a includes ends 5, 5a and 6, 6a, respectively. The ends 5, 5a and 6, 6a of each lever pair 7, 7a are fixed with articulated joints at edges of the primary mirror to the frame 2 on the back surface of the primary mirror 1. Each lever pair 7, 7a includes intersecting levers and opposite ends of each lever pair 7, 7a are fixed with articulated joints to moveable elements 8, 8a and 9, 9a, respectively. The moveable elements 8, 8a and 9, 9a are slidably placed on guides 10 and 10a, respectively. The guides 10, 10a are mounted in parallel to the back surface of the primary mirror 1 and at a horizontal height generally the same as a horizontal height of the ends 5, 5a and 6, 6a. The moveable elements 8, 8a and 9, 9a of the lever pairs 7, 7a are joined with a driving unit 11 and a switching on/off unit 13.

In one embodiment, as seen in FIGS. 1-4, the movable elements 8, 8a and 9, 9a comprise nuts, one set with a right-hand thread and a second set, symmetrically, with a left-hand thread. Accordingly, the guides 10, 10a comprise bolts.

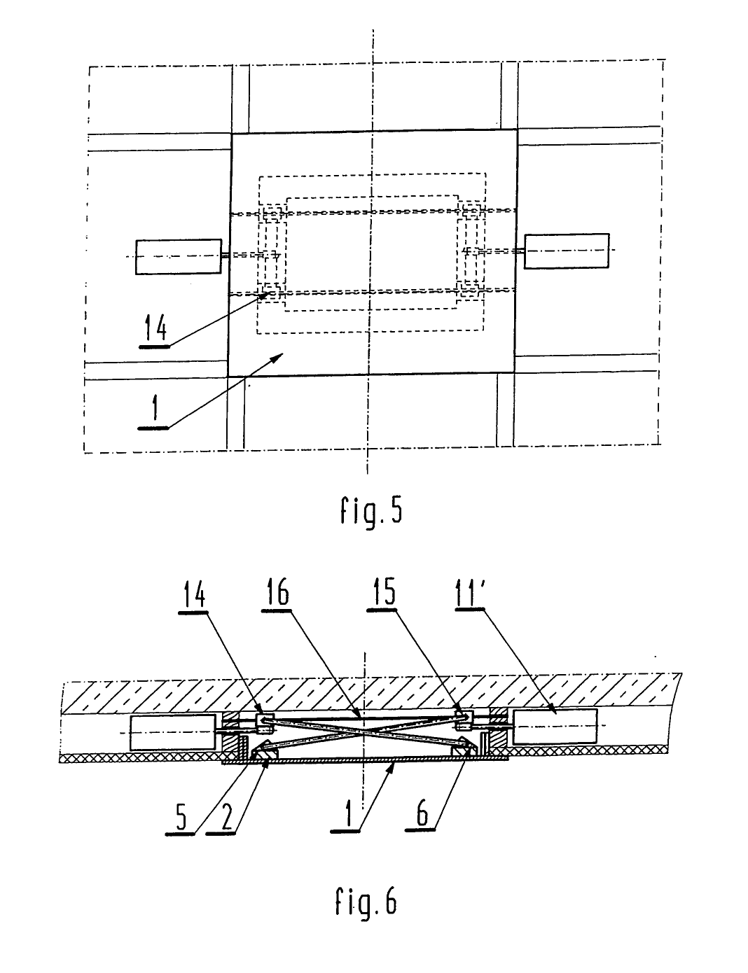

In a second embodiment, as seen in FIGS. 5 and 6, the movable elements 8, 8a and 9, 9a comprise slides 14 and 15. Accordingly, the guides 10, 10a are rods 16 or rails.

The driving unit 11 comprises an electric motor with a gear 12 and the switching on/off unit 13, a pneumatic or hydraulic actuator 11′, or the user's muscle strength.

After starting the driving unit 11, the moveable elements 8 and 9 of the first lever pair 7, and the moveable elements 8a and 9a of the second lever pair 7a move along the guides 10 and 10a, respectively. The opposite ends of lever pairs 7, 7a move horizontally along the guides 10, 10a and the levers of lever pairs 7, 7a push back horizontally the back surface of the primary mirror 1 integrated with the ends 5, 5a and 6, 6a. Accordingly, the back surface of the primary mirror 1 is moved outwardly away from wall 3 towards the inside of the room.

The mirror with slidable set of the present invention as illustrated in FIGS. 1-6 is typically used in bathrooms in framework structures. As such, the slidable set is completely inserted between the walls 3 and 3′. Alternatively, the space 4 between the walls 3, 3′ can be used for partial insertion of the slidable set. In this case the primary mirror is kept some distance off the inside bathroom wall towards the inside of the room. The slidable set construction is then hidden within a side casing 17, as illustrated in FIG. 4.

The mirror with slidable set of the present invention can also be used with traditional wall construction. As such, the primary mirror and slidable set are placed entirely inside the bathroom adjacent to the wall 3 and the slidable set is encased.

It is to be understood that the above description is intended to be illustrative and not limiting. Many embodiments will be apparent to those of skill in the art upon reading the above description. Therefore, the scope of the invention should be determined, not with reference to the above description, but instead with reference to the appended claims, along with the full scope of equivalents to which such claims are entitled.

1-3. (Cancelled).

4. A mirror with slidable set comprising:
a primary mirror having a back surface;
a slidable set integrated to the back surface of the primary mirror;
the slidable set comprising an end of at least one lever pair fixed to the back surface of the primary mirror, an opposite end of the at least one lever pair fixed to at least one moveable element mounted slidably on at least one guide, wherein the at least one guide is placed parallel to the back surface of the primary mirror, and wherein the at least one moveable element is joined to a driving unit.

5. The mirror with slidable set according to claim 4, wherein the driving unit further comprises a switching on/off unit.

6. The mirror with slidable set according to claim 4, wherein the at least one lever pair is fixed at each end with an articulated joint.

7. The mirror with slidable set according to claim 4, wherein the at least one guide is placed at a horizontal height generally the same as a horizontal height of the ends of the at least first lever pair.

8. The mirror with slidable set according to claim 4, wherein the at least one moveable element further comprises a threaded nut and the at least one guide further comprises a bolt.

9. The mirror with slidable set according to claim 4, wherein the at least one moveable element further comprises a slide and the at least one guide further comprises a rod or a rail.

10. The mirror with slidable set according to claim 4, wherein the at least one lever pair includes two generally intersecting levers.

11. The mirror with slidable set according to claim 4, wherein the driving unit comprises an electric motor.

12. The mirror with slidable set according to claim 4, wherein the driving unit comprises a pneumatic or hydraulic actuator.

13. The mirror with slidable set according to claim 4, further including a side casing for housing the slidable set.
